(19) United States
(12) Patent Application Publication
(10) Pub. No.: US 2025/0027847 A1
(43) Pub. Date: Jan. 23, 2025

(54) ICE MACHINE MONITORING SYSTEM AND METHODS

(71) Applicant: Lee Francisco, Marquette, MI (US)

(72) Inventor: Lee Francisco, Marquette, MI (US)

(21) Appl. No.: 18/777,061

(22) Filed: Jul. 18, 2024

Related U.S. Application Data
(60) Provisional application No. 63/527,418, filed on Jul. 18, 2023.

(51) Int. Cl. G01M 99/00

(52) U.S. Cl. CPC G01M 99/005; F25C 2600/04; F25C 2700/00; F25C 2700/14

(57) ABSTRACT

An ice machine monitoring system for monitoring and sensing of internal and external metrics in ice machines and reporting these metrics to a computing device. This captured data helps customers, technicians, and manufacturers to monitor issues such as ambient air temp, incoming water temp, incoming water flow, compressor surface temp, liquid line pressure, and suction line pressure. A sensor control receives data from a variety of sensors placed about the ice machine. The data is wirelessly transmitted to a cloud platform and through a communication platform is displayed on a computing device. In many cases, this provides a means for remote diagnosis of ice machine malfunctions. The ice machine monitoring system can be offered as an ice machine system retrofit kit for converting a standard ice machine to one having an ice machine monitoring system.

This application is a Non-Provisional Patent application claiming priority to Provisional Patent Application No. 63/527,418 filed Jul. 18, 2023, the entire disclosure of which is hereby incorporated by reference and relied upon.

### BACKGROUND OF THE INVENTION

### Field of the Invention

The invention relates generally to ice machine monitoring systems, and more particularly to systems for the continuous monitoring and sensing of internal and external metrics in ice machines.

### Description of Related Art

There are currently millions of ice machines in circulation as ice has become a necessity and critical for businesses. Therefore, it is important to have ice machines running reliably and efficiently. Most businesses have scheduled maintenance of the ice machines with a HVAC expert to help with the longevity of the machines, however, there are several common reasons the HVAC person is called in to diagnosis ice machine malfunction.

When an issue is reported for an ice machine, techs typically thoroughly inspect the ice machine to help diagnose issues. In doing so, there are many instances when a tech would find simple solutions to customer complaints. Issues such as the ambient air temp being too hot or cold, water temp being too hot or cold, and water being shut off at the source are all variables that can be easily fixed. In most cases, if a tech had those metrics related to these problems available, the tech would not need to be sent for a service call. Intermittent issues like a failing compressor or a leak in a compressor line, are far more difficult to detect. In most cases several service calls are required until a tech can properly witness the issues.

What is needed is a means to diagnose and report ice machine problems from a remote location. Such a system would help eliminate a majority of HVAC onsite visits to ice machines to fix simple problems. What is needed are aftermarket solutions that retrofit multiple sensors and monitoring in existing ice vending machines. In addition, what is needed are solutions for the conversion new ice machines at the factory to have diagnostic sensor and monitoring capabilities.

### SUMMARY OF THE INVENTION

Disclosed herein is an ice machine monitoring system that is capable of diagnosing malfunctions occurring in a remote ice machine.

In one form, issues that affect ice production in an ice machine are diagnosed by the use of common off the shelf sensors.

In one form, the ice machine monitoring system is a sensor system that integrates an array of sensors to capture continuous readings that impact an ice machine's productivity.

In one form, the sensors in the ice machine are retrofitted to work with existing ice machines and can capture data that helps customers, technicians, and manufacturers to monitor issues such as ambient air temp, incoming water temp, incoming water flow, compressor surface temp, liquid line pressure, and suction line pressure. Continuous monitoring of these metrics serves to help service techs and service companies avoid costly down times, costly service calls, and help diagnose issues with ice machines.

In one form, sensors along with diagnostic procedures are utilized to capture ice maker operating data and diagnose ice maker malfunctions.

In one form, sensors are utilized to continuously or intermittently track ice machine compressor surface temps.

In one form, sensors are utilized to continuously or intermittently track ice machine line pressures.

In one form, sensor data received from ice machine compressor surface temps and ice machine line pressures is analyzed to diagnose ice machine problems from a remote location.

In one form, the collecting and analysis of the ice machine sensor data is key to understanding if an ice machine compressor issue exists and how often the issue occurs.

In one form, an ice machine monitoring system comprises sensors operable for sensing internal and external ice machine operational metrics.

In one form, an ice machine monitoring system comprises a combination of both wired and wireless circuits.

In one form, an ice machine monitoring system comprises a sensor control box containing a main microprocessor, circuits, power, and communications chips.

In one form, operation of an ice machine monitoring system comprises externally connecting the ice machine sensors to the control box's expansion ports, collecting data from the sensors, and sending the data to the cloud.

In one form, the ice machine monitoring system comprises communications chips that can include but are not limited to Wi-Fi, lora, Bluetooth and cellular signal.

In one form, ice machine sensor data is collected every minute for all sensors and securely sent through an API cloud platform.

In one form, the ice machine monitoring system comprises a sensor control box that can be powered through one or both of: 5 volt USB, and existing power sources in the ice machine.

In one form, an ice machine cloud platform provides access to a custom dashboard to display alerts/notifications from the sensors.

In one form, cloud services for the ice machine monitoring system can be accessed through one or more of web browser, mobile app, push notifications and email.

In one form, an ice machine monitoring system utilizes a base microcontroller that powers, communicates, collects data from the sensors, and sends data.

In one form, the base microcontroller can send data to a cloud or local host.

In one form, data collected from sensors in an ice machine monitoring system will include ambient air temp using an NTC (negative temperature coefficient) thermistor.

In one form, data collected from sensors in an ice machine monitoring system will include water temp using an NTC thermistor.

In one form, data collected from sensors in an ice machine monitoring system will include water flow at an incoming water source.

In one form, data collected from sensors in an ice machine monitoring system will include compressor surface temp using an NTC Thermistor.

In one form, data collected from sensors in an ice machine monitoring system will include compressor suction line pressure using a pressure transducer sensor.

In one form, data collected from sensors in an ice machine monitoring system will include compressor liquid line pressure using a pressure transducer sensor.

In one form, data collected from sensors in an ice machine monitoring system will include one or more of: power source monitoring, dispensary ambient air temp, motion detection of ice release from trays, and dispensary ice level through infrared measurements.

In one form, a swivel T fitting with core depressor is utilized to monitor suction line pressure and liquid line pressure in an ice machine monitoring system. The swivel T fittings provide easy connection to the liquid and suction lines without cutting, soldering, or leaking any refrigerant. In addition, the swivel T also allows for service techs to access the lines for adding or removing refrigerant when servicing. It is noted however, that other types of connections can be utilized in these lines that are known in the art as an alternative to the swivel T. The swivel T offers convenience advantages.

In one form, an ice machine monitoring system is available as an ice machine monitoring system retrofit kit operable to convert a standard ice machine (without monitoring) to an ice machine equipped with an ice machine monitoring system. This conversion can occur at the factory when a new ice machine is being built, or in the field for ice machines currently in operation.

In one form, the ice machine monitoring system retrofit kit comprises, a compressor surface temp sensor, a compressor liquid line pressure sensor, a compressor suction line sensor, a water temperature sensor, a water flow sensor, an ambient air temp sensor, a sensor control, power and data lines for electrical communication between the sensors and sensor control, a cloud based platform app for communicating with the sensors, and a plurality of swivel T fittings.

In one form, the sensor control comprises control box power for powering the sensor control. The sensor control also has a microcontroller and communication chips.

### BRIEF DESCRIPTION OF THE SEVERAL VIEWS OF THE DRAWINGS

These and other features and advantages of the present invention will become more readily appreciated when considered in connection with the following detailed description and appended drawings, wherein each drawing is according to one or more embodiments shown and described herein, and wherein:

FIG. 1 depicts a schematic of an ice machine monitoring system within an ice machine;

FIG. 2 depicts a schematic of a sensor control from the ice machine monitoring system of FIG. 1 and its interaction with a cloud platform computing device;

FIG. 3 depicts a graphic illustrating examples of various types of computing devices which can be used in an ice machine monitoring system. The computing device can interact through the cloud with the sensor control box and database server;

FIG. 4 depicts a graphic illustrating examples of various components which can be used in a computing device of an ice machine monitoring system;

FIG. 5 depicts a flow diagram of a method of adding an ice machine monitoring system to a standard ice machine;

FIG. 6 depicts contents of an ice machine monitoring system retrofit kit;

FIG. 7 depicts an algorithm used to monitor air temperature surrounding an ice machine;

FIG. 8 depicts an algorithm used to monitor water temperature in an ice machine;

FIG. 9 depicts an algorithm used to monitor water flow in an ice machine;

FIG. 10 depicts an algorithm used to monitor compressor suction line and liquid line pressure in an ice machine;

FIG. 11 depicts an example of a graphic which can be displayed on a computing device associated with an ice machine monitoring system;

FIG. 12 depicts an example of a graphic which can be displayed on a computing device associated with an ice machine monitoring system.

### DETAILED DESCRIPTION OF SELECTED EMBODIMENTS OF THE INVENTION

Select embodiments of the invention will now be described with reference to the Figures. Like numerals indicate like or corresponding elements throughout the several views. The terminology used in the description presented herein is not intended to be interpreted in any limited or restrictive way, simply because it is being utilized in conjunction with detailed description of certain specific embodiments of the invention. Furthermore, embodiments of the invention may include several novel features, no single one of which is solely responsible for its desirable attributes or which is essential to practicing the invention described herein.

Disclosed herein is an ice machine monitoring system 100 that is capable of diagnosing onsite or remotely, malfunctions occurring in an ice machine 102. Remote in this instance means at a location distanced from the ice machine whereby the technician doesn't have physical access to the ice machine. When using the ice machine monitoring system 100 along with the cloud platform 133 for the monitoring system depicted in FIG. 2, issues that negatively affect ice production in an ice machine can in most cases be solved. This is accomplished by the use of operational data collected from common off the shelf sensors in the ice machine monitoring system. The monitoring system captures continuous or intermittent metric readings that impact an ice machine's productivity.

In a preferred embodiment, various sensors in the ice machine monitoring system are retrofitted to work with existing ice machines. The sensors can monitor and capture data that helps customers, technicians, and manufacturers monitor issues and ice maker malfunctions such as incorrect: ambient air temp, incoming water temp, incoming water flow, compressor surface temp, liquid line pressure, and suction line pressure. The various sensors can be utilized to continuously or intermittently capture data as needed to determine malfunctions.

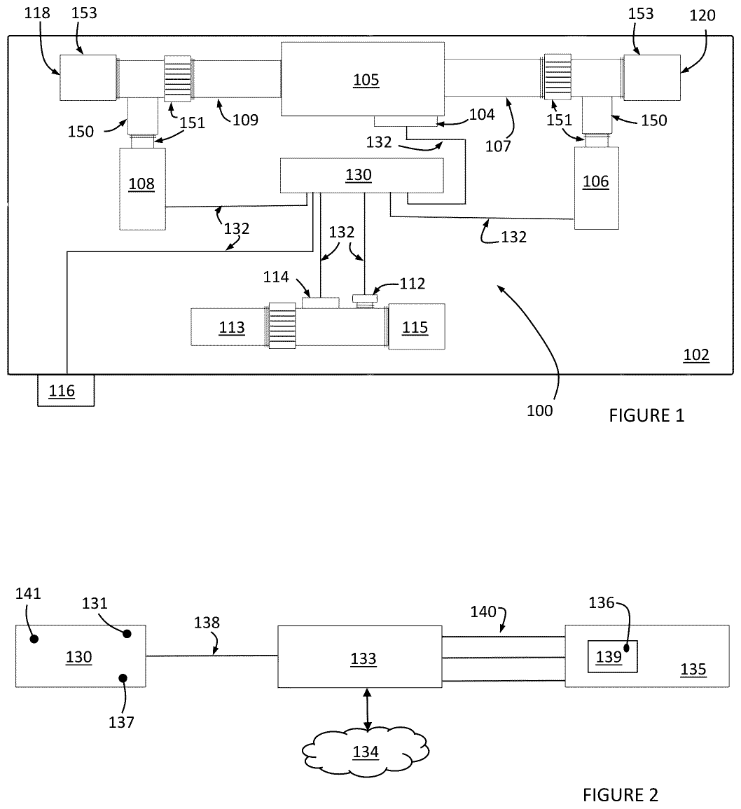

FIG. 1 depicts just a few of the components within an ice machine 102 that can be monitored by the aforementioned sensors. Ice machine 102 utilizes a compressor 105 to manufacture ice. For various reasons, the ice machine compressor 105 may overheat as indicated by its surface temps. A compressor surface temp sensor 104 in the form of an NTC thermistor is disposed on the compressor to monitor this temperature. Similarly, a service valve liquid line 120 is coupled to the ice machine's compressor 105. A compressor liquid line pressure sensor 106 is coupled with the compressor liquid line 107 to monitor pressure levels therein. Similarly, a service valve suction line 118 is coupled with the compressor's suction line 109. A compressor suction line sensor 108 is coupled with the compressor suction line 109 again to monitor pressure levels within the compressor suction line.

In one embodiment, ice machine sensor data is collected every minute for all sensors, however this frequency can be varied as desired. As further depicted in FIG. 1, data from the sensors is carried electrically through a variety of power and data lines 132 to a sensor control box 130 which contains a microcontroller 131 (FIG. 2) capable of receiving the data and preparing it to be uploaded to an API cloud platform 133. This upload can utilize use wireless data 140 protocols such as WiFi, cellular, LoRa, Bluetooth, to work with API data. Wireless communication chips 137 are integrated into central control box 130 for this wireless data transmission. Therefore, the ice machine monitoring system 100 comprises a combination of both wired (i.e. power/data) and wireless circuits (i.e. WiFi).

The ice machine monitoring system 100 comprises a sensor control box 130 containing a main microprocessor/microcontroller, circuits, control box power 141, and communications chips 137. The various ice machine sensors are electrically connected to the sensor control box's 130 expansion ports via the power/data lines 132 thereby collecting data from the various sensors and sending the data to the cloud 134.

In this embodiment, sensor control box 130 is powered through one or both of: 5 volt USB, and other existing power sources in the ice machine 102. The ice machine monitoring system 100 utilizes a base microcontroller 131 that powers, communicates, collects, and sends wireless data 138 to a cloud or local host. The ice machine cloud platform 133 provides the user access through one or more communication platforms 140 such as a web browser, mobile app, and API integrations from a computing device 135. Client facing media 136 output from the cloud platform can include but is not limited to push notifications, alerts, texts, and email. This media is viewable via a display 139 of a custom dashboard. The dashboard displays these client facing options 136 as insight to the data from one or more of the ice machine sensors.

Other sensors included in an ice machine monitoring system can include ambient air temperature. In this embodiment, data regarding ambient temperature is from using an ambient air temp sensor 116 NTC (negative temperature coefficient) in the form of an NTC thermistor. Data collected from sensors in an ice machine monitoring system 100 will include water temp sensor 112 also using an NTC thermistor.

Water flow is monitored at an incoming water source 113 by a water flow sensor 114 as it passes to an outflow water supply 115 that is used to make ice.

Described above are the sensors used in preferred embodiments, however, additional sensors can be used. For example, data collected from sensors in an ice machine monitoring system can include one or more of power source monitoring, dispensary ambient air temp, motion detection of ice release from trays, and dispensary ice level through infrared measurements.

A swivel T fitting 150 with core depressor is utilized in various portions of the ice machine monitoring system 100 such as to monitor compressor suction line 109 pressure and compressor liquid line 107 pressure in the ice machine monitoring system 100. The swivel T fittings 150 provide easy connection to the liquid and suction lines without cutting, soldering, or leaking any refrigerant. Flare fittings 151 and flare fitting caps 153 can be used to join various lines together or access various lines. Other fittings, such as standard T fittings can be used as an alternative.

Standard ice machines (absent an ice machine monitoring system) can be converted to an ice machine equipped with an ice machine monitoring system 100 via use of an ice machine monitoring system retrofit kit 152 as depicted in FIG. 6. In some embodiments, the ice machine monitoring system retrofit kit 152 comprises a compressor surface temp sensor 104 operable for sensing the surface temperature of an ice machine's compressor, a compressor liquid line pressure sensor 106 operable for sensing line pressure in the liquid line, a compressor suction line sensor 108 operable for sensing suction line pressures, a water temperature sensor 112 operable for sensing the temperature of the incoming water to an ice machine, a water flow sensor 114 operable to sense the incoming water flow rate, and an ambient air temp sensor 116 operable for sensing the ambient air temp. In addition, the ice machine monitoring system retrofit kit 152 comprises, a sensor control 130 operable to receive sensor data from the various sensors via power/data lines 132 also in the kit. The ice machine monitoring system retrofit kit 152 also comprises a cloud-based platform app 133 operable for communicating with the sensors, and can also include a plurality of swivel T fittings 150.

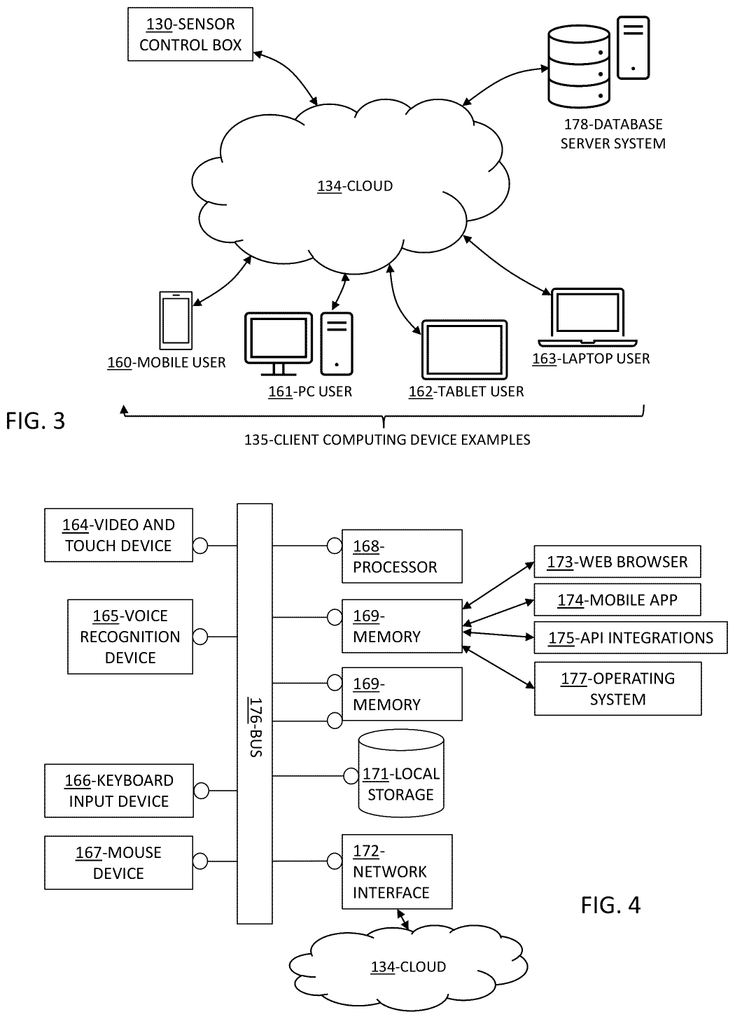

FIG. 3 depicts examples of different types of computing devices 135 which can be used to communicate with the cloud 134. These include mobile devices 160, PCs 161, tablets 162, and laptops 163. These devices communicate through cloud platform 133 to the cloud 134 to receive the metric data from sensor control box 130. As depicted in FIG. 4, computing device 135 can include components that communicate through a bus 176. Examples of these components include a video and touch device 164, a voice recognition device 165, a keyboard input device 166, a mouse device 167, a computer processor 168, memory 169, local storage 171, and a network interface 172. Operating through memory 169 can include an operating system 177, mobile applications 174, API integrations 175, and a web browser 173. These devices can communicate as needed through cloud 134 to ice machine monitoring database server system 178 and/or sensor control box 130.

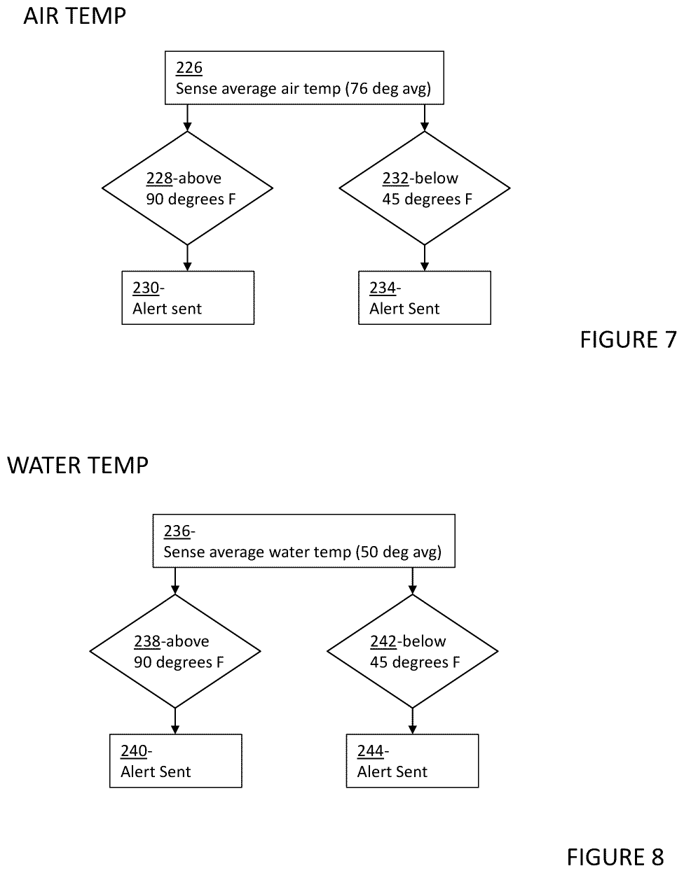

FIGS. 7-10 depict algorithms responding to various metrics measured by the ice machine monitoring system 100. In FIG. 7, the ambient air temperature sensor 116 senses the air temperature (226) and communicates this data to sensor control 130 before wirelessly transmitting the data to the cloud platform 133. As one example, ambient air temperature can be expressed as an average temperature by averaging temperatures at idle, at the start of the freeze cycle, at peak freeze cycle, and at the end of the freeze cycle. If the air temperature is above 90F (228) for example, an alert can sent (230) via email, text, or push notification for viewing on display 139 of computing device 135. High air temperatures typically negatively affect ice production as it will take longer for the water to freeze. An abnormally high or low air temperature can be indicative of an environmental issue such as air flow or heat/AC failure.

Similarly, as depicted in FIG. 8, the water temperature sensor 112 senses the water temperature (236) and communicates this data to sensor control 130 before wirelessly transmitting the data to the cloud platform 133. In one example, average water temperatures are determined from the average water temperature at idle, at the start of the freeze cycle, at peak freeze cycle, and at the end of the freeze cycle. If the water temperature is above 90F (238) for example, an alert is sent (240) for viewing on display 139 of computing device 135. If the water temperature is below 45 degrees fahrenheit, an alert is sent (244) is sent indicating this issue. Like other alerts, the average water temperature triggering the alert can be adjusted by the user. High water temperatures will negatively affect ice production as it will take longer for the water to freeze.

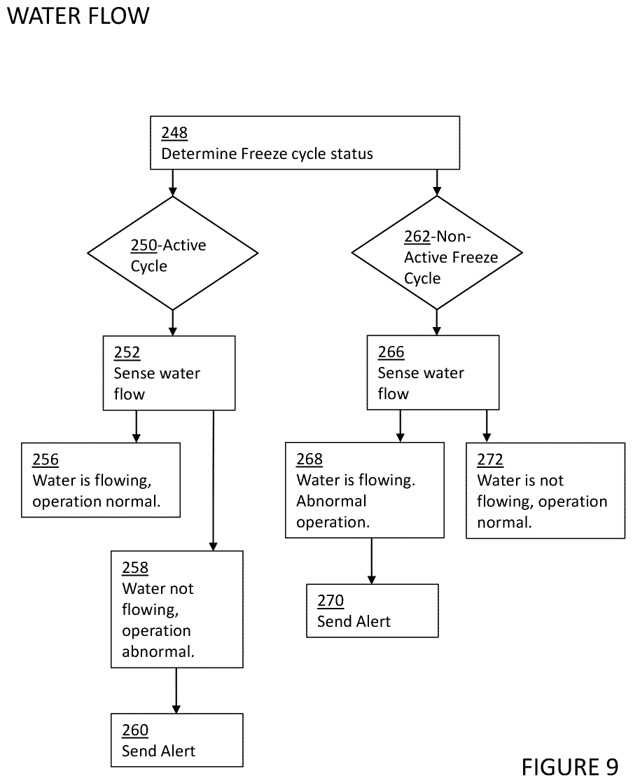

As depicted in FIG. 9, the ice machine monitoring system determines whether water is flowing or not flowing at the appropriate times during an active or inactive freeze cycle. The system determines the freeze cycle status (248). During an active freeze cycle (250), water flow is sensed (252) based on data sent by water flow sensor 114. If water is flowing, this is considered normal (256). If water is not flowing, this is considered to be abnormal operation (258) and the ice machine monitoring system sends an alert (260) regarding this problem. Upon determining a non-active freeze cycle (262), water flow is also sensed (266). If water is not flowing, this is considered normal operation (272). If water is flowing, this is considered abnormal operation (268) and the ice machine monitoring system sends an alert (270) regarding this problem. In other words, during a non-active freeze cycle of normal operation, liquid flow and suction should be at idle. On the other hand, during an active freeze cycle in normal operation, liquid flow should be higher than idle and suction lower than idle resulting in the flow of water. In one example, average water flow measurement and duration is captured at idle, start of freeze cycle, peak freeze cycle, and end of freeze cycle. Most ice machines only draw water at the start of the freeze cycle for a few seconds and then during the peak freeze cycle. If the machine is in a freeze cycle and no water has been drawn, an alert will be sent regarding a water flow issue.

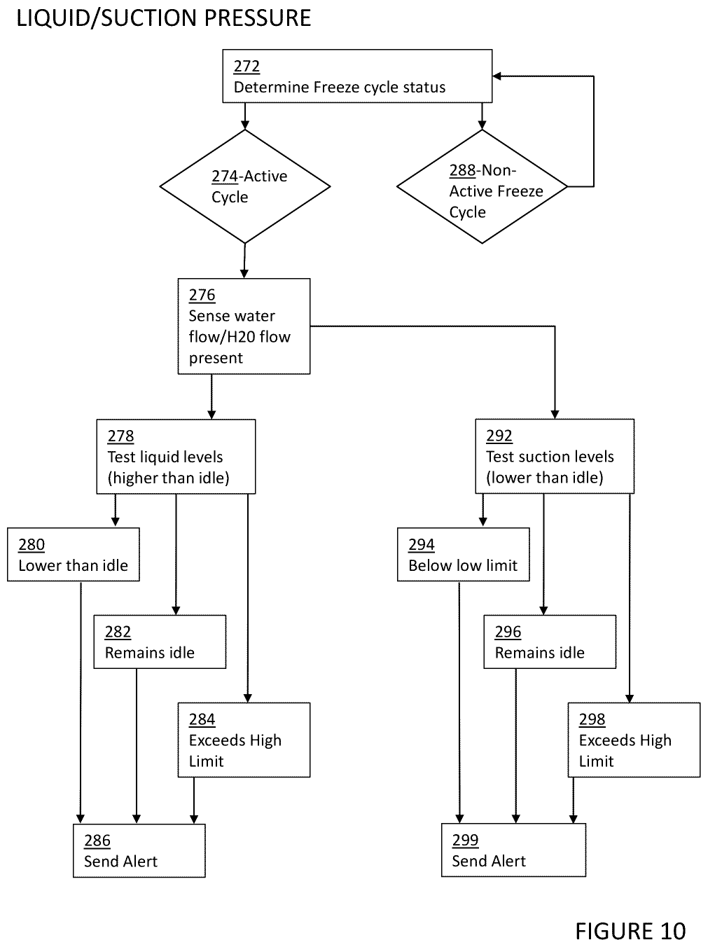

As depicted in FIG. 10, the ice machine monitoring system determines whether there is appropriate liquid levels and suction levels during an active freeze cycle. This process begins with the system determining the freeze cycle status (272). If the state is a non-active freeze cycle (288), no further action is needed. During an active freeze cycle (274), water flow is sensed (276) based on data sent by water flow sensor 114. If water is flowing, this is considered normal as previously noted (256). At this point, liquid levels are tested based on data received from the compressor liquid line pressure sensor 106. The test liquid levels should be higher than levels when the ice maker is at idle (278). If the sensor determines the liquid levels are lower than idle (280), an alert is sent indicating this abnormal metric (286). If the sensor determines the liquid levels remain idle (282), an alert is sent indicating this abnormal metric (286). If the sensor determines the liquid levels are higher but exceed a high limit (284), an alert is sent indicating this abnormal metric (286). In some embodiments, average liquid pressure line readings are determined by averaging line readings at idle, start of the freeze cycle, peak freeze cycle, and end of freeze cycle. By using the combination of water flow readings, liquid pressure and suction pressure, a determination can be made about when a freeze cycle starts. If the Liquid Pressures are higher or lower than average, an alert can be sent indicating a potential malfunction.

Concurrently, suction levels are tested based (FIG. 10) on data received from the compressor suction line sensor 108. The test suction levels should be lower than levels when the ice maker is at idle (292). If the sensor determines the suction levels are lower than idle yet also below a low limit (294), an alert is sent indicating this abnormal metric (299). If the sensor determines the suction levels remain idle (296), an alert is sent indicating this abnormal metric (299). If the sensor determines the suction levels exceed a high limit (298), an alert is sent indicating this abnormal metric (299). In some embodiments, average suction pressure line readings and duration are determined by averaging these line readings at idle, start of freeze cycle, peak freeze cycle, and end of freeze cycle. By using the combination of water flow readings, liquid pressure and suction pressure, the start of a freeze cycle can be determined. If the suction pressures are higher or lower than average, the system can be set to send an alert when these levels are met to indicate a potential malfunction.

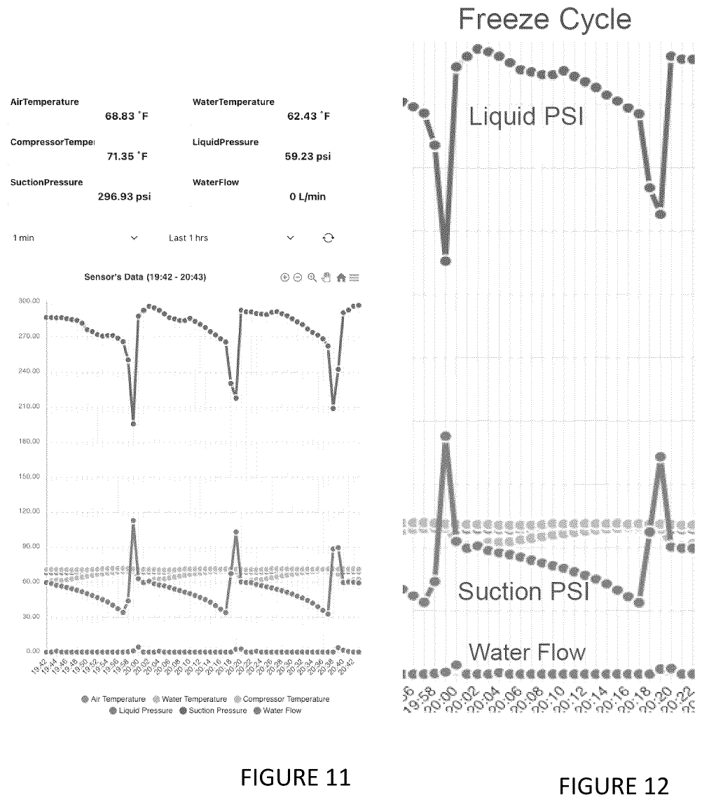

FIGS. 11-12 depict one embodiment of visual output from the ice machine monitoring system viewing on a display 139 of a computing device 135 in communication with the ice machine monitoring system 100. As noted in the FIG. 11 graphic, displayed are metrics such as air temperature (grey), compressor temperature (green), suction pressure (purple), water temperature (gold), liquid pressure (red), and water flow (blue). As noted, user selected options include options to adjust the span of time data is depicted (i.e. 1 hour) and the frequency at which the data is sampled (i.e. every 1 minute). The display example here graphically depicts changes in these metrics as the ice machine cycles through active and inactive freeze cycles. FIG. 12 depicts a close-up view of one freeze cycle and the changes that occur based in data received from the various ice machine monitoring system sensors. Again, the capture frequency of sensor data can be adjusted. For example, if sensor data is captured every 2 seconds, it allows technicians to view data points at virtually any given time. This allows technicians to identify possible intermittent issues and outliers.

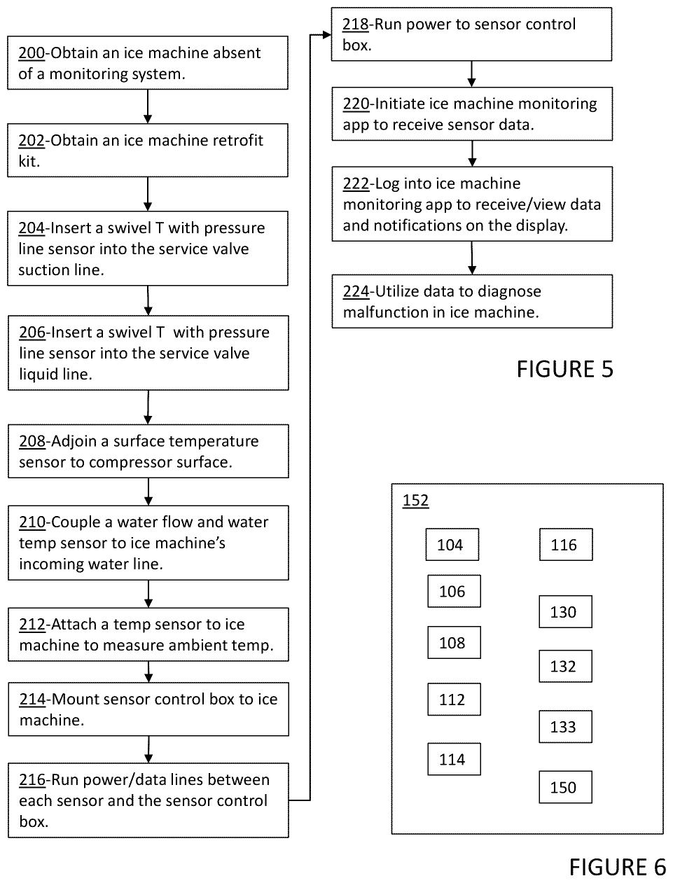

In one embodiment, FIG. 5 depicts a method of converting an ice machine absent a ice machine monitoring system to have an ice machine monitoring system 100 and using it to monitor normal and abnormal operation of the ice machine 102. The method comprises the following steps. Obtain an ice machine absent of a monitoring system (200). The ice machine can be a new standard ice machine still at the factory, or the standard ice machine can be an operating ice machine in the field at a remote location. Obtain an ice machine retrofit kit (202) such as for example, the one described earlier and depicted in FIG. 6. Insert a swivel T with pressure line sensor into the service valve suction line of the ice machine (204). Insert a swivel T with pressure line sensor into the service valve liquid line (206). Adjoin a surface temperature sensor to a surface of the compressor such as the compressor's outer surface (208). Couple a water flow and water temp sensor to the ice machine's incoming water line (210). Attach a temperature sensor to the ice machine to measure ambient temperature (212). Mount a sensor control box to the ice machine (214). Run power/data lines between each sensor and the sensor control box (216). Run electrical power to the sensor box (218). Initiate an ice machine monitoring app to receive sensor data from the ice machine sensors (220). Log into the ice machine monitoring app to receive and view ice machine sensor data and notifications on the display of the computing device running the ice machine monitoring app (222). Utilize the data received to diagnose malfunction in the ice machine (224).

As disclosed previously, computing devices interfacing with an ice machine monitoring system may include; one or more processor(s), one or more memory device(s), one or more interface(s), one or more local or remote mass storage device(s), one or more of Input/Output (I/O) device(s) such as a mouse and keyboard and voice recognition and video and touch device, and one or more display, all of which are coupled to a bus. Processor(s) include one or more processors and controllers that execute instructions stored in memory device(s) and mass storage device(s). Processor(s) may also include various types of computer-readable media, such as cache memory.

Memory device(s) within an ice machine monitoring system may include one or more various computer-readable media, such as volatile memory (e.g., random access memory (RAM)) and nonvolatile memory (e.g., read-only memory (ROM)). Memory device(s) may also include rewritable ROM, such as flash memory. A memory device may also be in the form of mass storage device(s) including various computer readable media, such as magnetic tapes, magnetic disks, optical disks, solid-state memory (e.g., flash memory), and so forth. Mass storage devices may be in the form of a hard disk drive to serve various computing devices. Various drives may also be included in mass storage device(s) to enable reading from and/or writing to the various computer readable media. Mass storage device(s) may include removable media and/or non-removable media.

Memory may be used for storing an operating system, application programs such as web browsers, other program modules, and program data. I/O device(s) include one or more of various devices that allow data and other information to be input to and retrieved from computing device(s). Example I/O device(s) include one or more of; cursor control devices, keyboards, keypads, microphones, monitors and other display devices, speakers, printers, network interface cards, modems, lenses, CCDs and other image capture devices, and the like.

Display devices include any type of device capable of displaying information to one or more users of a computing device in communication with a web service system. Examples of display devices include a monitor, display terminal, video projection device, and the like. A monitor and other types of display devices may also be connected to a system bus via an interface, such as a video interface. A graphics interface may also be connected to a system bus. One or more graphics processing units (GPUs) may communicate with a graphics interface. In this regard, GPUs generally include on-chip memory storage, such as register storage and GPUs communicate with a video memory. GPUs, however, are but one example of a coprocessor and thus a variety of co-processing devices may be included in a computer. In addition to a monitor, computers may also include other peripheral output devices such as speakers and printer, which may be connected through an output peripheral interface.

A bus allows processor(s), memory device(s), interface(s), mass storage device(s), and I/O device(s) to communicate with one another, as well as other devices and components coupled to the bus. Bus represents one or more of several types of bus structures including a memory bus and memory controller, a peripheral bus, a system bus, and a local bus using any variety of bus architectures. By way of example and not limitation, these may include PCI bus, IEEE 1394 bus, USB bus, ISA bus, MCA bus, EISA bus, and VESA local bus.

One of ordinary skill in the art can appreciate that a computer or other client device can be deployed as part of a computer network. In this regard, the present invention pertains to any computer system having any number of memory and storage units, and any number of applications and processes occurring across any number of storage units and volumes. The present invention may apply to an environment with server computers and client computers deployed in a network environment, having one or more of remote and local storage. The present invention may also apply to a standalone computing device, having programming language functionality, interpretation, and execution capabilities.

Interface(s) include various interfaces that allow any computing devices to interact with other systems, devices, and computing environments. Example interface(s) include any number of different network interfaces, such as interfaces to local area networks (LANs), wide area networks (WANs), wireless networks, and the Internet. Other interface(s) include user interface and peripheral device interface. An interface(s) may also include one or more user interface elements. An interface(s) may also include one or more peripheral interfaces such as interfaces for printers, pointing devices (mice, track pad, etc.), keyboards, and the like.

Embodiments can also be implemented in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

For purposes of illustration, programs and other executable program components are shown herein as discrete blocks, although it is understood that such programs and components may reside at various times in different storage components of a computing device, and are executed by processor(s). Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

It is noted that the terms “substantially” and “about” and “generally” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

The foregoing invention has been described in accordance with the relevant legal standards, thus the description is exemplary rather than limiting in nature. Variations and modifications to the disclosed embodiment may become apparent to those skilled in the art and fall within the scope of the invention.

1. An ice machine monitoring system comprising:
a sensor control;
a micro control housed in said sensor control;
a computing device;
said computing device having a display;
at least one pressure sensor operable for sensing pressure in a compressor suction line of an ice machine and producing data metrics thereof;
at least one pressure sensor operable for sensing pressure in a compressor liquid line of an ice machine and producing data metrics thereof;
at least one water temperature sensor operable for sensing water temperature in an incoming water supply of an ice machine and producing data metrics thereof;
at least one water flow sensor operable for sensing water flow in an incoming water supply of an ice machine and producing data metrics thereof;
at least one compressor surface temperature sensor operable for sensing temperature of a compressor of an ice machine and producing data metrics thereof;
said pressure sensors, temperature sensors, water flow sensors in communication with said sensor control;
a communication chip housed in said sensor control;
a cloud platform;
said communication chip operable to transmit data metrics from said pressure sensors, temperature sensors, and said water flow sensors to said cloud platform; and,
wherein said data metrics can be displayed on said display for remotely diagnosing malfunctions of said ice machine.

2. The ice machine monitoring system of claim 1 wherein said communication chip wirelessly transmits said data metrics using one or more of: WiFi, Cellular, LoRa, Bluetooth, and API data.

3. The ice machine monitoring system of claim 1 wherein said computing device interacts with said cloud platform by use of one or more of: a web browser, a mobile application, and API integrations.

4. The ice machine monitoring system of claim 1 wherein said pressure sensor is coupled to said compressor liquid line by use of a swivel T fitting.

5. The ice machine monitoring system of claim 1 wherein said pressure sensor is coupled to said compressor suction line by use of a swivel T fitting.

6. The ice machine monitoring system of claim 5 wherein said swivel T comprises a core depressor.

7. The ice machine monitoring system of claim 1 further comprising:
a sensor control power supply operable to supply power to said sensor control.

8. The ice machine monitoring system of claim 1 further comprising an ambient air temperature sensor operable for sensing the temperature of the ambient air surrounding an ice machine.

9. The ice machine monitoring system of claim 1 wherein an alert is sent for display when one of said pressure sensors, temperature sensors, and water flow sensors detects a parameter that is out of a specified tolerance.

10. The ice machine monitoring system of claim 9 wherein said alert is in the form of one or more of: an email, a push notification, and a text.

11. The ice machine monitoring system of claim 1 wherein said ice machine monitoring system is contained within the ice machine.

12. An ice machine monitoring system comprising:
a sensor control;
a microcontroller housed in said sensor control;
at least one pressure sensor operable for sensing pressure in a compressor suction line of an ice machine and producing data metrics thereof;
at least one pressure sensor operable for sensing pressure in a compressor liquid line of an ice machine and producing data metrics thereof;
at least one water temperature sensor operable for sensing water temperature in an incoming water supply of an ice machine and producing data metrics thereof;
at least one water flow sensor operable for sensing water flow in an incoming water supply of an ice machine and producing data metrics thereof;
at least one compressor surface temperature sensor operable for sensing temperature of a compressor of an ice machine and producing data metrics thereof;
said pressure sensors, temperature sensors, and water flow sensors operable for electrical communication with said sensor control;
a communication chip housed in said sensor control;
a cloud platform;
said communication chip operable to transmit said data metrics from said pressure sensors, temperature sensors, and said water flow sensors to said cloud platform; and,
wherein said data metrics can be displayed on said display for remotely diagnosing malfunctions of said ice machine.

13. The ice machine monitoring system of claim 12 further comprising:
a computing device; and,
wherein said computing device comprises a display.

14. The ice machine monitoring system of claim 12 wherein said communication chip wirelessly transmits said data metrics using one or more of: WiFi, Cellular, LoRa, Bluetooth, and API data.

15. The ice machine monitoring system of claim 13 wherein said computing device interacts with said cloud platform by use of one or more of: a web browser, a mobile application, and API integrations.

16. The ice machine monitoring system of claim 12 wherein an alert is sent for display when one of said pressure sensors, temperature sensors, and water flow sensors detects a parameter that is out of a specified tolerance.

17. The method of converting an ice machine absent of an ice machine monitoring system to an ice machine having an ice machine monitoring system comprising the steps of:
obtaining an ice machine absent an ice machine monitoring system;
obtaining an ice machine retrofit kit;
inserting a swivel T with pressure line sensor into the service valve suction line;
inserting a swivel T with pressure line sensor into the service valve liquid line;
adjoining a surface temperature sensor to the surface of the ice machine compressor;
coupling a water flow and water temp sensor to the ice machine's incoming water line;
attaching a temperature sensor to the ice machine to measure ambient temperature;
mounting a sensor control box to the ice machine; and,
running power and data lines between each sensor and the sensor control box.

18. The method of claim 17 further comprising the steps of:
initiating an ice machine monitoring app;
logging into the ice machine monitoring app to review data and notifications; and,
utilizing the data and notifications to diagnose malfunction in the ice machine.

19. A ice machine retrofit kit for converting an ice machine absent of an ice machine monitoring system to an ice machine having an ice machine monitoring system comprising one or more of:
a compressor surface temp sensor;
a compressor liquid line pressure sensor;
a compressor suction line sensor;
a water temp sensor;
a water flow sensor;
an ambient air temp sensor;
a sensor control;
power and data lines; and,
a swivel T fitting.

20. The ice machine retrofit kit of claim 19 further comprising:
an ice machine monitoring cloud platform.
